(19) United States
(12) Patent Application Publication
(10) Pub. No.: US 2025/0282331 A1
(43) Pub. Date: Sep. 11, 2025

(54) Electric lifting mechanism for automatic balancing system

(71) Applicant: VIETTEL GROUP, Ha Noi City (VN)

(72) Inventors: VAN DINH PHAM, Ha Noi City (VN); KIM BAO LE, Song Lo District (VN); DUY TUNG NGUYEN, Hanoi City (VN); PHAM TUAN NGUYEN, Ha Noi City (VN); QUANG UY NGUYEN, Ha Noi City (VN); VAN DICH PHAM, Hung Yen City (VN)

(73) Assignee: VIETTEL GROUP, Ha Noi City (VN)

(21) Appl. No.: 19/037,174

(22) Filed: Jan. 25, 2025

(30) Foreign Application Priority Data
Mar. 8, 2024 (VN) 1-2024-01737

(51) Int. Cl. B60S 9/06

(52) U.S. Cl. CPC B60S 9/06

(57) ABSTRACT

The electric lifting mechanism for the automatic balancing system uses two or more lifting mechanisms and combines with high-precision angle measuring sensors to balance in the desired directions or planes. The structure is used for balancing systems on truck cranes, radar trucks, fire trucks and military forklifts or other systems that require balancing. The system has large lifting force, compact size, high control precision and the ability to balance in a short time.

### SCOPE OF THE INVENTION

The invention covers an electric lifting mechanism for automatic balancing system. Specifically, the invention refers to the electric lifting mechanisms for automatic balancing systems on truck cranes, radar vehicles, firetrucks and military forklifts.

### TECHNICAL STATUS OF THE INVENTION

In recent years, along with the development of science and technology, electric lifting systems have been widely used because of their easy controllability, accuracy and high automation capabilities. In reality, there are many different lifting methods and structures, each of them has its own advantages and disadvantages.

The conventional mechanical lifting system is simple and easy to manufacture, but is very difficult to operate and takes a long time for balance to adjust.

The lifting system, which uses hydraulic cylinders, has a simple structure, is easy to manufacture and has a large lifting force, but its disadvantages are that it easily causes oil leakage, the structure is bulky, and the control accuracy is not high.

To overcome the disadvantages of the above mentioning structures, the authors proposed to invent an electric lifting mechanism for automatic balancing system. The system uses electrical motors combining with the mechanical structures and control systems for automatic balancing systems with large loads and high precision. The system is capable of working in harsh weather conditions.

### TECHNICAL NATURE OF THE INVENTION

The purpose of the invention is to propose an electric lifting mechanism for automatic balancing system with large lifting force and compact size, combined with high-precision sensors to automate the balancing system for vehicle, such as radar vehicles, truck cranes, firetrucks and military forklifts.

In order to achieve the above purpose, the electric lifting mechanism for the automatic balancing system mentioned in the invention includes: The motor (1) is the source of rotational force and transmits torque through the gear reduction box (2) to increase the torque through the meshing gear mechanism, the gears that can be used are straight gears, helical gears, and bevel gears. The gear reduction box (2) is linked to the transfer flange (3) to connect to the shell (5) of the lifting mechanism. The output shaft of the gear reduction box (2) is linked to one end of the planetary screw stiffener assembly (14) through the transmission coupling (13). The planetary screw stiffener assembly (14) is connected to the displacement assembly (16) through rigid joints and connecting bolts. The limit switch sensor cluster (7) and origin sensor cluster (15) have the effect of controlling the maximum travel and determining the zero origin for the electric lifting system. The base assembly (12) is made from steel, steel alloy, aluminum, and aluminum alloy welded together to form a load-bearing structure and is connected to the load-bearing ball (17) through joints and bolts to be connected to the displacement assembly (16) by welded joints.

The electric lifting mechanism for the automatic balancing system uses three to four lifting mechanisms and high-precision sensors to balance the vehicles through a balance calculation control system to control the displacement movement of lifting mechanisms. The system has large lifting force, compact size, high control precision and the ability to balance in a short time.

### BRIEF DESCRIPTION OF THE DRAWINGS

FIG. 1 is front side view and cross-section A-A of the electric lifting mechanism;

FIG. 2 is front side view and cross-section B-B of the limit switch sensor cluster;

FIG. 3 is front side view and C-C section of the planetary screw stiffening support assembly;

FIG. 4 is front side view and D-D section of moving assembly of the electric lifting mechanism; and

FIG. 5 is front side view and top side view of the base assembly.

### DETAILED DESCRIPTION

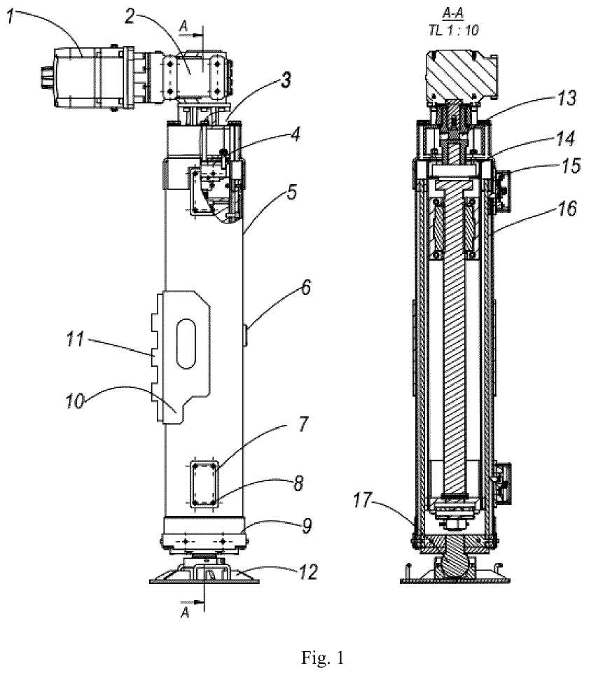

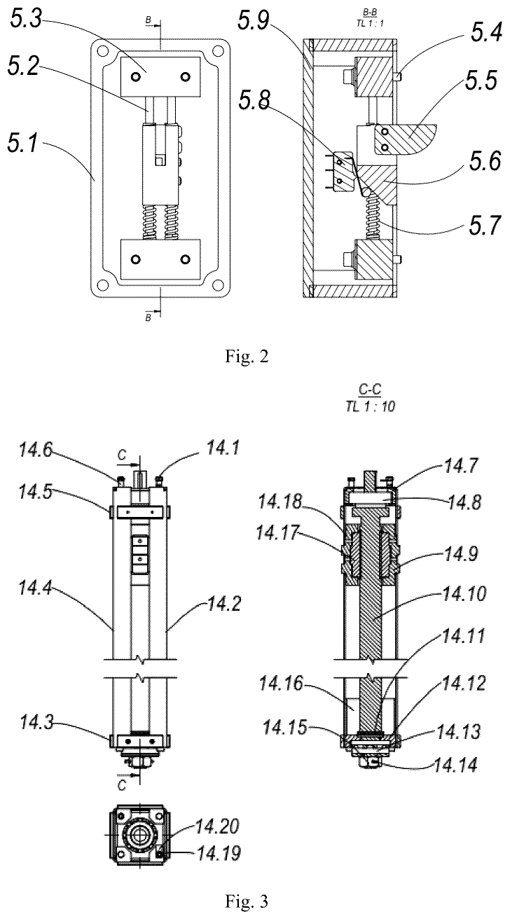

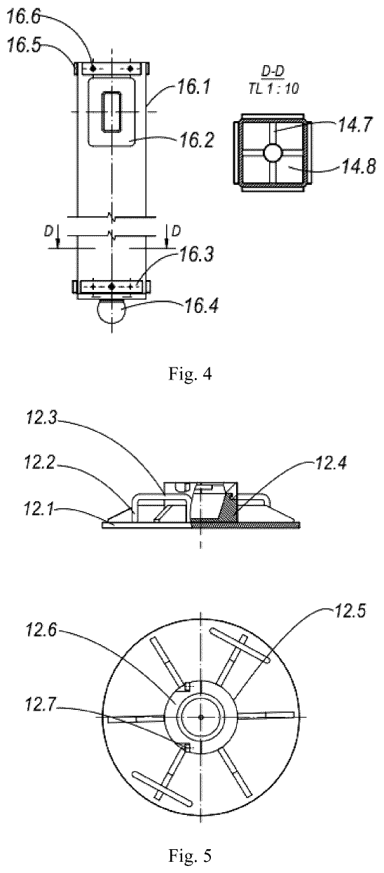

The purpose of the invention is to propose an electric lifting mechanism for a system that automatically balances large loads, with compact size, high accuracy, and quick response for application to vehicle systems that require balancing with high precision such as radar trucks, crane vehicles, and firetrucks. Refer to the drawings from FIGS. 1 to 5, the basic structure of this invention includes parts linked together by welded connections or bolted connections as follows:

The electric lifting mechanism for the automatic balancing system mentioned in the invention includes:

Motor 1: can be a single-phase or three-phase motor or a DC motor with integrated high-precision rotary position sensor. Motor 1 rotates and transmits motion and torque through gear reduction box 2 to increase torque through the meshing gear mechanism, the gears that can be used are the spur gears, helical gears, and bevel gears.

The gear reduction box 2 is linked to the transfer flange 3 to connect with the cover 5 of the lifting mechanism. The output shaft of the gear reduction box 2 is linked to one end of the planetary screw stiffening support assembly 14 through the transmission coupling 13.

Transfer flange 3 is applied to connect between gear reduction box 2 and cover 5.

Sensor trigger mechanism 4 is the mechanism that triggers the ground contact sensor when the cylinder moves. The sensor trigger mechanism 4 can be made from plastic materials, made from aluminum, aluminum alloy, steel, steel alloy, composite.

Cover 5 is the outer part of the electric lifting mechanism assembly, which has the role of protecting the internal parts and components that make up the electric lifting mechanism assembly.

Product nameplate 6, which clearly states the parameters of size, volume and load of the product. The product nameplate 6 is made from stainless steel, aluminum or aluminum alloy, plastic or steel, steel alloy.

Limit switch sensor cluster 7 and origin sensor cluster 15 have the effect of controlling the maximum travel and determining origin 0 for the electric lifting system. In this invention, the limit switch sensor cluster 7 and the original sensor cluster 15 in the electric lifting mechanism for the automatic balancing system have an assembly structure including: sensor box 5.1, guide slider 5.2, slider bracket 5.3, slider bracket fixing bolt 5.4, motion trigger mechanism 5.5, sensor trigger displacement mechanism 5.6, push spring mechanism 5.7, limit switch 5.8. The 5.1 sensor box is made from aluminum, aluminum alloy, steel, steel alloy, composite, the box protects the internal electronic components from environmental impacts and creates a bracket for integrating equipment. Guide slider 5.2 is made from steel, a circular steel alloy consisting of two parallel bars. The slider bracket 5.3 is made from aluminum, aluminum alloy, steel, and steel alloy to fix the guide slider 5.2. The slider bracket fixing bolt 5.4 has the effect of permanently assembling the mounting base with the cover 5. The motion trigger mechanism 5.5 is linked to the sensor trigger displacement mechanism 5.6 by bolts, when the moving assembly 16 will touch the motion trigger mechanism 5.5 through the sensor trigger displacement mechanism 5.6 and activate the limit switch 5.8, the sensor trigger displacement mechanism 5.6 has two lugs with distances 5 mm to activate two limit switches installed in parallel to ensure safety, in case the first limit switch has a problem, the second switch will be activated to ensure structural safety. The push spring mechanism 5.7 has the effect of pushing the sensor trigger displacement mechanism 5.6 to deactivate the limit switch 5.8 when the displacement cluster 16 moves in the opposite direction.

Connecting bolt 8 serves to connect the limit switch sensor cluster 7 and the cover 5.

The sliding bearing assembly 9 is made from steel, steel alloy, aluminum, and aluminum alloy and is connected to the cover 5 with bolts to fix the sliding bearing.

stiffener support 10 are made from steel, steel alloy, aluminum, aluminum alloy and are welded to the cover 5 to support for the cover 5.

connecting support 11 is made from steel, steel alloy, aluminum, aluminum alloy welded with stiffener support 10. On the connecting support, there are serrated grooves to prevent slipping and increase bearing capacity.

base assembly 12 is made from steel, steel alloy, aluminum, and aluminum alloy welded together to form a load-bearing structure and is linked to the load-bearing ball 17 through joints and bolts to connect to the displacement assembly 16 by welded joints. Specifically, in this invention, the base assembly 12 in the electric lifting mechanism for the automatic balancing system has an assembly structure including: base plate 12.1, base stiffening support 12.2, base arm 12.3, lower half bridge 12.4, first upper half bridge 12.5, second upper half bridge 12.6, connecting bolts 12.7. In which the base plate 12.1 is made from steel, steel alloy, aluminum, aluminum alloy is welded with base stiffening support 12.2 and base arm 12.3 to move when disassembled and assembled. In addition, base plate 12.1 is additionally welded to the lower half bridge 12.4 at the center to ensure balanced force distribution. The lower half bridge 12.4 is machined from steel, steel alloy, aluminum, monolithic aluminum alloy with a clamp to connect with the first upper half bridge 12.5 and the second upper half bridge 12.6 and is clamped with connecting bolts 12.7 to assemble the base with load bearing ball 17.

Transmission coupling 13 has the role of transmitting motion and torque from the motor to the lead screw assembly. The transmission coupling 13 can be made from plastic materials, aluminum alloys, steel alloys or copper alloys.

Planetary screw stiffener assembly 14 is linked to displacement assembly 16 through hard joints and connecting bolts. In this invention, the planetary screw stiffener assembly 14 has an assembly structure including: first locating and guiding pin 14.1 and second locating and guiding pin 14.6, first stiffener bar 14.2 and second stiffener bar 14.4, first self-lubricating sliders 14.3 and second self-lubricating sliders 14.5, upper thrust ball bearing support 14.7, first thrust ball bearing 14.8, sliding and anti-rotation mechanism 14.9, planetary lead screw 14.10, ball bearing 14.11, lower thrust ball bearing support 14.12, second thrust ball bearing 14.13, anti-loosening pin 14.14, anti-loosening bolt 14.15, stiffener support 14.16, planetary nut 14.17, sliding bearing 14.18, connecting bolt 14.19, ground contact sensor 14.20. In which the first guiding pin 14.1 and the second 14.6 are made from alloy steel, titanium, and titanium alloy to both position and guide the lead screw stiffener assembly with the body cover 5, these two pins have a circular or cylindrical structure and one end has a thread to connect with the nut. The first stiffener bar 14.2 and the second 14.4 are composed of two U-shaped halves made from steel, steel alloy, aluminum, aluminum alloy, titanium, titanium alloy. The two stiffener bars are connected by bolts to the upper thrust ball bearing support 14.7 and the lower thrust ball bearing support 14.12. Upper thrust ball bearing support 14.7 and lower thrust ball bearing support 14.12 are made from steel, steel alloy, aluminum, aluminum alloy, precision machined and ensure concentric assembly between the two bearings. The first self-lubricating sliders 14.3 and second 14.5 are made from self-lubricating plastic materials, copper, copper alloy, which help guide and reduce friction for moving mechanisms. The first 14.8 and second 14.13 thrust ball bearings are steel, steel alloy ball bearings that can withstand high axial loads. The sliding and anti-rotation mechanism 14.9 is made up of two parts joined together by bolts and clamped with crystal nuts 14.17, made from materials of steel, steel alloy, aluminum alloy, composite and is installed with sliding bearing 14.8 to slide along the first lead screw stiffener bar 14.2 and second 14.4. Planetary lead screw 14.10 is made from steel, high strength steel alloy, can withstand large loads. Ball bearing 14.11 supports the planetary lead screw to ensure concentric motion without vibration. The anti-loosening pin 14.14 has the effect of preventing loosening of the anti-loosening bolt 14.15, keeping the second ball bearing 14.13 from loosening. Stiffener rib 14.16 is made from steel, steel alloy, aluminum, aluminum alloy and is welded to the first stiffener bar 14.2 and second 14.4. Connecting bolts 14.19 are high-strength bolts made from steel, steel alloy, and stainless steel, on which the installation position of ground contact sensor 14.20 is machined to return a notification signal when the mechanism is activated. lift and touch the ground.

The displacement assembly 16 in the electric lifting mechanism for the automatic balancing system has an assembly structure including: displacement body assembly 16.1 made from steel, steel alloy, aluminum, aluminum alloy or composite shaped like square box. Stiffening ribbed plate 16.2 is made from steel, steel alloy, aluminum, and welded aluminum alloy to stiffen the displacement assembly at the position of high force. The first self-lubricating bearing 16.3 and the second 16.5 are made from self-lubricating plastic, copper, and copper alloy to guide and reduce friction during the movement of moving mechanisms. The bearings are connected to the moving body by bolt connections 16.6. Load-bearing ball bearing 16.4 is made from steel, steel alloy, titanium, and titanium alloy to adjust the force direction for the base assembly 12 and ensure the base always contacts the ground on a flat surface. Stiffening rib bar 16.7 and base plate 16.8 are made from steel, steel alloy, aluminum alloy, welded in place with load-bearing ball bearing 16.4, which increases the load-bearing capacity of the displacement body assembly 16.1. Load-bearing ball bearing 17 is made from steel, steel alloy, aluminum, aluminum alloy, titanium, and titanium alloy to bear the force and automatically adjust the force direction for the base assembly.

### BENEFITS ACHIEVED BY THE INVENTION

Electric lifting mechanism for automatic balancing system used on trucks cranes, radar trucks, fire trucks and military forklifts.

In order to balance the system, two or more lifting mechanisms can be applied at the same time combined with angle sensors for automatic balancing control. The system will automatically balance in a short time to ensure accuracy and safety for people and equipment that needs protection. The system has large lifting force, compact size, and high control precision.

1. An electric lifting mechanism for the automatic balancing system includes:
a motor being a single-phase or three-phase motor or a DC motor with a built-in high-precision angle sensor; the motor rotates and transmits motion and torque through a gear reduction box to increase torque through a gear mechanism, wherein gears that can be used are spur gears, helical gears, and bevel gears;
the gear reduction box is linked to a transfer flange to connect to a cover of the lifting mechanism; an output shaft of the gear reduction box is linked to a first end of a planetary screw stiffener assembly through a transmission coupling;
the transfer flange is used to connect between the gear reduction box and the cover;
a sensor trigger mechanism is a mechanism that activates a ground contact sensor when a cylinder moves; the sensor trigger mechanism can be made from plastic materials, made from aluminum, aluminum alloy, steel, steel alloy, composite;
the cover is an outer part of an electric lifting mechanism assembly, with the role of protecting internal parts and components constituting the electric lifting mechanism assembly;
a product nameplate clearly states the parameters of size, volume and load of the electric lifting mechanism; the product nameplate is made from stainless steel, aluminum or aluminum alloy, plastic or steel, steel alloy;
a limit switch sensor cluster and an origin sensor cluster have the effect of controlling a maximum travel and determining a zero origin for the electric lifting mechanism;
a connecting bolt serves to connect the limit switch sensor cluster and the cover;
a stiffener plate, made from steel, steel alloy, aluminum, and aluminum alloy, is connected to the cover with bolts to fix a sliding bearing;
stiffener support are made from steel, steel alloy, aluminum, aluminum alloy welded to the cover to support for the cover;
connecting support are made from steel, steel alloy, aluminum, aluminum alloy welded with the stiffening support, on link tendons there are serrated grooves to prevent slipping and increase bearing capacity;
a base assembly is made from steel, steel alloy, aluminum, and aluminum alloy welded together to form a load-bearing structure and is connected to a load-bearing ball through joints and bolts to connected to a displacement assembly by welded joints;
a transmission coupling has a role of transmitting motion and torque from the motor to the lead screw assembly; the transmission coupling being made from plastic materials, aluminum alloys, steel alloys or copper alloys;
a planetary screw stiffening assembly linked to the displacement assembly through rigid joints and connecting bolts;
the displacement assembly in the electric lifting mechanism for the automatic balancing system has an assembly structure including: a displacement body assembly, a stiffening support plate, a first self-lubricating bearing and a second self-lubricating bearing, a load-bearing ball bearing, bolts, a stiffener support bar and base plates;
the load bearing ball is made from steel, steel alloy, aluminum alloy, titanium, titanium alloy to bear the force and self-direct force for the base assembly.

2. The electric lifting mechanism for the automatic balancing system according to claim 1, in which:
the planetary screw stiffener assembly has an assembly structure including: a first locating and guiding pin and a second locating and guiding pin, a first stiffener bar and a second stiffener bar, a first and a second self-lubricating sliders, an upper thrust ball bearing support, a first thrust ball bearing, a sliding and anti-rotation mechanism, a planetary lead screw, a ball bearing, a lower thrust ball bearing support, a second thrust ball bearing, an anti-loosening pin, an anti-loosening bolt, a stiffener support, a planetary nut, a sliding bearing, a connecting bolt, a ground contact sensor; in which the first and second locating and guiding pins are made from alloy steel, titanium, and titanium alloy to both position and guide the lead screw stiffener assembly with the cover, these two pins having a circular or cylindrical structure and one end has a thread to connect with the nut; the first and second stiffener bars are composed of two U-shaped halves made from steel, steel alloy, aluminum, aluminum alloy, titanium, titanium alloy; two stiffeners are connected by bolts to the upper thrust ball bearing support and the lower thrust ball bearing support; upper thrust ball bearing support and lower thrust ball bearing support being made from steel, steel alloy, aluminum, aluminum alloy, precision machined and ensure concentric assembly between the two bearings; the first and second self-lubricating sliders being made from self-lubricating plastic, copper, and copper alloy materials, which help guide and reduce friction for moving mechanisms; the first and second thrust ball bearings being steel, steel alloy ball bearings that can withstand high axial loads; the sliding and anti-rotation mechanism being made of two parts joined together by bolts and clamped with the planetary nut, made from materials of steel, steel alloy, aluminum and aluminum alloy, composite and fitted with the sliding bearing to slide along the first and second stiffener bars; planetary lead screw being made from steel, high strength steel alloy, to withstand large loads; ball bearing has an effect of supporting the planetary lead screw to ensure concentric motion without vibration; the anti-loosening pin has an effect of preventing loosening of the anti-loosening bolt to keep the second thrust ball bearing from loosening; stiffener support being made from steel, steel alloy, aluminum, aluminum alloy and are welded to the first and second stiffener bars; connecting bolts are high-strength bolts made from steel, steel alloy, and stainless steel, on which the installation position of the ground contact sensor being machined to return a communication signal alarm when the lifting mechanism touches the ground.

3. The electric lifting mechanism for the automatic balancing system according to claim 1, in which:
the displacement assembly (16) includes: the displacement body assembly made from steel, steel alloy, aluminum, aluminum alloy or composite with square box structure; stiffening support plate being made from steel, steel alloy, aluminum, aluminum alloy welded to stiffen the displacement assembly at the position of high force; the first and second self-lubricating bearings being made from self-lubricating plastic, copper, and copper alloy to guide and reduce friction during the movement of moving mechanisms; the bearings are connected to the moving body by the bolt connections; load-bearing ball bearing being made from steel, steel alloy, titanium, titanium alloy, which has the effect of adjusting a force direction for the base assembly and ensuring that the base is always in contact with the ground on a flat surface; stiffening support bar and base plate being made from steel, steel alloy, aluminum alloy, welded in place with the load-bearing ball bearing, which increases a load-bearing capacity of the displacement body assembly.

4. The electric lifting mechanism for the automatic balancing system according to claim 1, in which:
the limit switch sensor cluster and the original sensor cluster include: a sensor box, a guide slider, a slider bracket, a slider bracket fixing bolt, a motion trigger mechanism, a sensor trigger displacement mechanism, a push spring mechanism, a limit switch, the sensor box being made from aluminum, aluminum alloy, steel, steel alloy, composite, the box protecting internal electronic components from environmental impacts and creates a bracket for placing equipment, guide slider being made from steel, a circular steel alloy consisting of two parallel bars the slider bracket being made from aluminum, aluminum alloy, steel, and steel alloy to fix the guide slider, the slider bracket fixing bolt has an effect of permanently assembling the mounting base with the shell, the motion trigger mechanism being linked to the sensor trigger displacement mechanism by bolts, when the displacement assembly shifts it will touch the motion trigger mechanism through the sensor trigger shift mechanism and actuate the limit switch, the sensor trigger displacement mechanism has two lugs with distance 5 mm to activate two limit switches installed in parallel to ensure safety, in case the first limit switch has a problem, the second switch will be activated to ensure structural safety, the push spring mechanism has an effect of pushing the sensor trigger displacement mechanism to deactivate the limit switch when the displacement cluster moves in an opposite direction.

5. The electric lifting mechanism for the automatic balancing system according to claim 1, in which:
the base assembly includes: a base plate, a base stiffening support, a base arm, a lower half bridge, a first upper half bridge, a second upper half bridge, and connecting bolts, in which the base plate being made from steel, steel alloy, aluminum, aluminum alloy and is welded with base stiffening support and base arm to move when disassembled and assembled, in addition, the base plate is additionally welded to the lower half bridge at a center to ensure balanced force distribution, the lower half bridge being machined from steel, steel alloy, aluminum, monolithic aluminum alloy with a clamp to connect with the first upper half bridge and the second upper half bridge and is clamped with connecting bolts to assemble the base with the load bearing ball.
